(19) United States
(12) Patent Application Publication
(10) Pub. No.: US 2023/0334479 A1
(43) Pub. Date: Oct. 19, 2023

(54) CERTIFICATE VERIFICATION METHOD AND APPARATUS USING NON-FUNGIBLE TOKEN

(71) Applicant: ELECTRONICS AND TELECOMMUNICATIONS RESEARCH INSTITUTE, Daejeon (KR)

(72) Inventor: Jae-Hoon NAH, Daejeon (KR)

(73) Assignee: ELECTRONICS AND TELECOMMUNICATIONS RESEARCH INSTITUTE, Daejeon (KR)

(21) Appl. No.: 18/156,940

(22) Filed: Jan. 19, 2023

(30) Foreign Application Priority Data
Apr. 18, 2022 (KR) 10-2022-0047440

(51) Int. Cl. G06Q 20/38; G06Q 20/12; G06Q 20/40

(52) U.S. Cl. CPC G06Q 20/38215; G06Q 20/1235; G06Q 20/389; G06Q 20/4014; G06Q 2220/00

(57) ABSTRACT

Disclosed herein are a certificate verification method and apparatus using a Non-Fungible Token (NFT). The certificate verification method includes receiving a user Identification(ID) and a certificate image, extracting Optical Character Reader (OCR) data from the certificate image, generating metadata based on the OCR data, and verifying a certificate by comparing content of a token registered in a blockchain based on the user ID with the generated metadata.

### CROSS REFERENCE TO RELATED APPLICATION

This application claims the benefit of Korean Patent Application No. 10-2022-0047440, filed Apr. 18, 2022, which is hereby incorporated by reference in its entirety into this application.

### BACKGROUND OF THE INVENTION

### 1. Technical Field

The present disclosure relates generally to a certificate verification method and apparatus using a Non-Fungible Token (NFT) to identify the original of a certificate and verify the forgery of the certificate.

### 2. Description of the Related Art

Generally, a web-based content confirmation service for compliance test reports (certificates) is based on paper, and thus a problem may arise in that details of test certificates are forged or counterfeited. To solve this problem, watermark paper, a hologram, or the like is used in test certificates, but the possibility of forgery/counterfeit occurring offline still remains.

Because a service for confirming test certificates is a one-way service for searching for stored information and is configured to allow a user to verify information displayed on a monitor with the naked eye, a problem may arise in that errors may be made by the user.

Further, as a server for confirming test certificates is replaced, there is the possibility of infringing the integrity (forgery/counterfeit) of contents in the test certificates. That is, there is the possibility of damages to the contents occurring depending on the task of increasing server capacity and improving the functionality of the server.

### SUMMARY OF THE INVENTION

Accordingly, the present disclosure has been made keeping in mind the above problems occurring in the prior art, and an object of the present disclosure is to provide a certificate verification method and apparatus using a Non-Fungible Token (NFT), which can prevent the forgery or counterfeit of a paper certificate.

In accordance with an aspect of the present disclosure to accomplish the above object, there is provided a certificate verification method using a Non-Fungible Token (NFT), including receiving a user Identification(ID) and a certificate image, extracting Optical Character Reader (OCR) data from the certificate image, generating metadata based on the OCR data, and verifying a certificate by comparing content of a token registered in a blockchain based on the user ID with the generated metadata.

The certificate image may be generated by scanning a paper certificate on a user terminal.

The paper certificate may include at least one of a test report, a test certificate, a certificate of qualifications, a certificate of a degree, a transcript or a vaccination passport, or a combination thereof.

The metadata may include a least one of a document number, an issuance date, an item or an expiration date, or a combination thereof.

The blockchain may be configured such that the user ID, a token, and a Uniform Resource Identifier (URI) enabling corresponding information to access an InterPlanetary File System (IPFS) are registered in a form of [User ID, Token ID, URI].

The content of the token registered in advance in the blockchain may include comparison target metadata stored in the IPFS.

The certificate verification method may further include, when the generated metadata matches the comparison target metadata, providing a normal determination message to a user.

The certificate verification method may further include, when the generated metadata does not match the comparison target metadata, providing a forgery determination message and a message for explaining a reason for forgery determination to a user.

In accordance with another aspect of the present disclosure to accomplish the above object, there is provided a certificate verification apparatus using a Non-Fungible Token (NFT), including a memory configured to store a control program for verifying a certificate, and a processor configured to execute the control program stored in the memory, wherein the processor is configured to receive a user Identification(ID) and a certificate image, extract Optical Character Reader (OCR) data from the certificate image, generate metadata based on the OCR data, and verify a certificate by comparing content of a token registered in a blockchain based on the user ID with the generated metadata.

The certificate image may be generated by scanning a paper certificate on a user terminal.

The paper certificate may include at least one of a test report, a test certificate, a certificate of qualifications, a certificate of a degree, a transcript or a vaccination passport, or a combination thereof.

The metadata may include a least one of a document number, an issuance date, an item or an expiration date, or a combination thereof.

The blockchain may be configured such that the user ID, a token, and a Uniform Resource Identifier (URI) enabling corresponding information to access an InterPlanetary File System (IPFS) are registered in a form of [User ID, Token ID, URI].

The content of the token registered in advance in the blockchain may include comparison target metadata stored in the IPFS.

The processor may be configured to, when the generated metadata matches the comparison target metadata, provide a normal determination message to a user.

The processor may be configured to, when the generated metadata does not match the comparison target metadata, provide a forgery determination message and a message for explaining a reason for forgery determination to a user.

### BRIEF DESCRIPTION OF THE DRAWINGS

The above and other objects, features and advantages of the present disclosure will be more clearly understood from the following detailed description taken in conjunction with the accompanying drawings, in which:

FIG. 1 is a block diagram illustrating a certificate verification apparatus using a Non-Fungible Token (NFT) according to an embodiment of the present disclosure;

FIG. 2 is a block diagram illustrating the detailed configuration of a certificate verification apparatus using an NFT according to an embodiment of the present disclosure;

FIG. 3 is a flowchart illustrating a certificate verification method using an NFT according to an embodiment of the present disclosure;

FIG. 4 is a flow diagram illustrating a certificate registration process according to another embodiment of the present disclosure;

FIG. 5 is a flow diagram illustrating in detail a certificate verification method according to a further embodiment of the present disclosure; and

FIG. 6 is a block diagram illustrating the configuration of a computer system according to an embodiment.

### DESCRIPTION OF THE PREFERRED EMBODIMENTS

Advantages and features of the present disclosure and methods for achieving the same will be clarified with reference to embodiments described later in detail together with the accompanying drawings. However, the present disclosure is capable of being implemented in various forms, and is not limited to the embodiments described later, and these embodiments are provided so that this disclosure will be thorough and complete and will fully convey the scope of the present disclosure to those skilled in the art. The present disclosure should be defined by the scope of the accompanying claims. The same reference numerals are used to designate the same components throughout the specification.

It will be understood that, although the terms “first” and “second” may be used herein to describe various components, these components are not limited by these terms. These terms are only used to distinguish one component from another component. Therefore, it will be apparent that a first component, which will be described below, may alternatively be a second component without departing from the technical spirit of the present disclosure.

The terms used in the present specification are merely used to describe embodiments, and are not intended to limit the present disclosure. In the present specification, a singular expression includes the plural sense unless a description to the contrary is specifically made in context. It should be understood that the term “comprises” or “comprising” used in the specification implies that a described component or step is not intended to exclude the possibility that one or more other components or steps will be present or added.

Unless differently defined, all terms used in the present specification can be construed as having the same meanings as terms generally understood by those skilled in the art to which the present disclosure pertains. Further, terms defined in generally used dictionaries are not to be interpreted as having ideal or excessively formal meanings unless they are definitely defined in the present specification.

Embodiments of the present disclosure will now be described in detail with reference to the accompanying drawings. Like numerals refer to like elements throughout, and overlapping descriptions will be omitted.

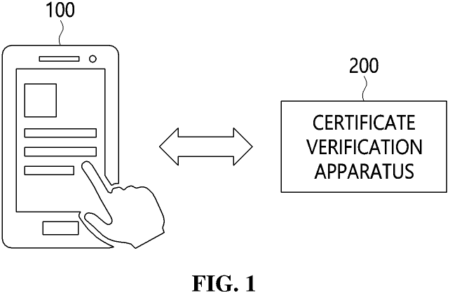

FIG. 1 is a block diagram illustrating a certificate verification apparatus using a Non-fungible Token (NFT) according to an embodiment of the present disclosure.

Referring to FIG. 1, a certificate verification apparatus 200 according to an embodiment may be provided with a user ID and a certificate image from a user terminal 100. The user terminal 100 may scan a paper certificate and generate a scanned certificate image. For this, the certificate verification apparatus 200 may further include a scan function of scanning the paper certificate provided by a user.

The paper certificate may include, but is not limited to, a test report, a test certificate, a certificate of qualifications, a certificate of a degree, a transcript, a vaccination passport, etc.

The certificate verification apparatus 200 may extract Optical Character Reader (OCR) data from the certificate image, generate metadata from the extracted OCR data, and verify forgery/counterfeit of the certificate by comparing the generated metadata with the content of a comparison target token prestored in a block chain.

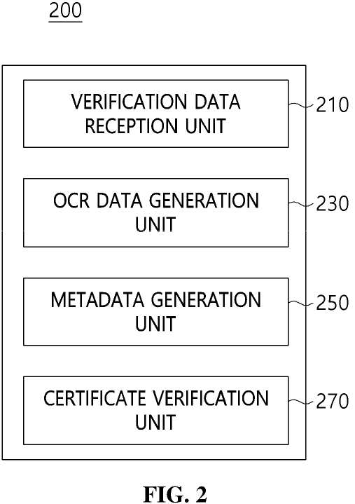

As illustrated in FIG. 2, the certificate verification apparatus 200 according to an embodiment may include a verification data reception unit 210, an OCR data generation unit 230, a metadata generation unit 250, a token creation unit (not illustrated), and a certificate verification unit 270.

The verification data reception unit 210 may receive a certificate image. The verification data reception unit 210 may receive a user ID enabling a user to be identified, together with the certificate image. The user ID may be registered and obtained when the user initially accesses the certificate verification apparatus. For example, an email address may be used as the user ID, but the user ID is not limited thereto.

The OCR data generation unit 230 may generate OCR data by extracting the OCR data based on the received certificate image.

The OCR data generation unit 230 may generate the OCR data by recognizing a character or a numeral recognized from the certificate image.

The metadata generation unit 250 may extract (generate) metadata from the OCR data in conformity with the format of metadata. The metadata may include, but is not limited to, a document number, an issuance date, an item, an expiration date, etc.

The certificate verification unit 270 may calculate and generate a hash value from the extracted metadata using a normal hash algorithm, and may determine whether the certificate is authentic by comparing the generated hash value with the content of a token registered in a blockchain.

In detail, the certificate verification unit 270 may transfer a token ID to the blockchain through the user ID, and may then search for the token corresponding to the token ID. When the token is found in the blockchain, comparison target metadata may be fetched from an InterPlanetary File System (IPFS), and may be compared with the extracted metadata.

When the extracted metadata matches the content of the token registered in the blockchain, a normal determination message may be provided to the user.

On the other hand, when the extracted metadata does not match the content of the token registered in the blockchain, a forgery determination message and a message for explaining the reason for forgery determination may be provided to the user.

In the blockchain, in a process of registering the certificate in advance, a certificate that is a reference is processed as OCR data, metadata is generated from the OCR data, and a token is created from the metadata, and thus the created token, a user ID, and a Uniform Resource Identifier (URI) enabling the corresponding information to access the InterPlanetary File System (IPFS) may be stored in the form of [User ID, Token ID, URI]. Here, meta-information may be stored in the IPFS in an off-chain state.

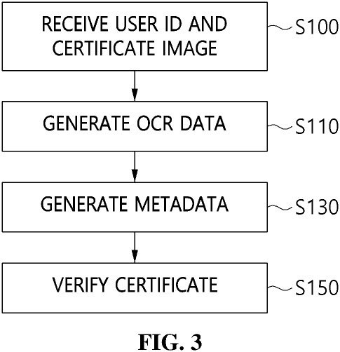

FIG. 3 is a flowchart illustrating a certificate verification method using an NFT according to an embodiment of the present disclosure. Here, the certificate verification method may be performed by a certificate verification apparatus.

Referring to FIG. 3, the certificate verification apparatus 200 may receive a user ID and a certificate image requested to be verified from a user terminal at step S100.

The certificate verification apparatus 200 may generate OCR data by extracting the OCR data from the certificate image at step S 110. Here, the certificate verification apparatus 200 may generate metadata from the OCR data at step S130.

The certificate verification apparatus 200 may calculate and generate a hash value from the generated metadata using a typical hash algorithm, and may verify the corresponding certificate by comparing the generated hash value with the content of a token registered in a blockchain at step S150.

In detail, the certificate verification apparatus 200 may transfer a token ID to the blockchain through a user ID, and may search for a token corresponding to the token ID. When the token is found in the blockchain, comparison target metadata may be fetched from the IPFS, and may be compared with the generated metadata.

Hereinafter, a process for registering a paper certificate in a blockchain and a process for verifying the certificate according to embodiments will be described.

First, a user may perform the process for registering a user ID in a Decentralized Application (DAPP) through a web or a smartphone application before registering the certificate.

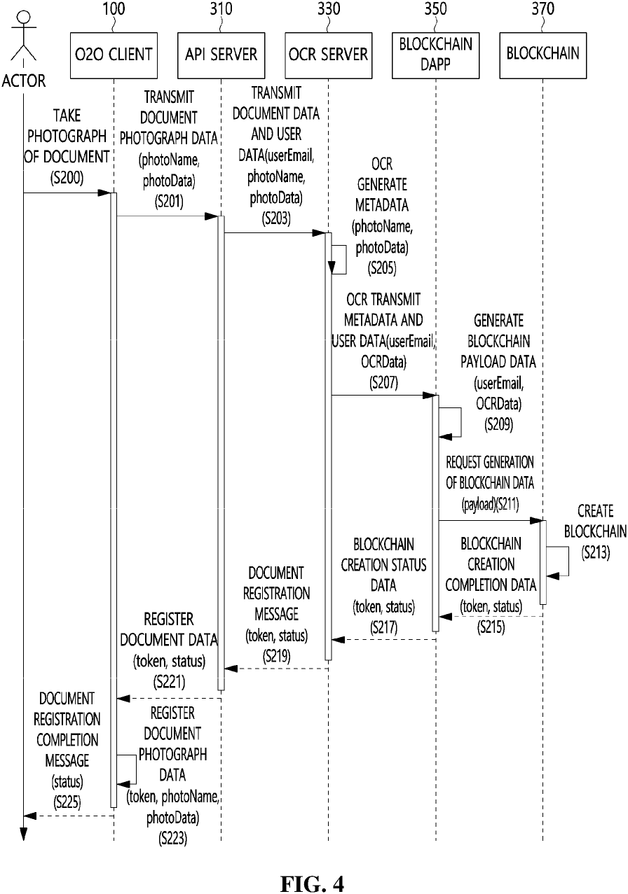

FIG. 4 is a flow diagram illustrating a process for registering a certificate according to an embodiment of the present disclosure.

Referring to FIG. 4, when a user takes a photograph of a document corresponding to a paper certificate that is a reference on the screen of a Online to Offline (O2O) client 100 at step S200, document photograph data may be transferred to an Application Programming Interface (API) server 310 at step S201. Here, the document photograph data may be a certificate image.

The API server 310 may transmit document data and user data to an OCR server 330 at step S203. Here, the user data may be a user ID.

The OCR server 330 may generate OCR data based on the received document data, and may generate metadata from the generated OCR data in conformity with the format of metadata at step S205. The metadata and the user data may be transmitted to a blockchain Decentralized Application (DAPP) 350 at step S207. Here, the metadata may be registered in an InterPlanetary File System (IPFS).

The blockchain DAPP 350 may generate blockchain payload data at step S209, and may request the generation of blockchain data at step S211.

Thereafter, a blockchain 370 may be created at step S213, and blockchain creation completion data (a token ID and a status value) may be transferred to the blockchain DAPP 350 at step S215. When a blockchain creation status value is true, the corresponding token ID may be stored, together with the user ID, in a database.

The OCR server 330 may transfer a message related to registration of a document to the API server 310 at step S219. The API server 310 may register the document data in an O2O client 100, and also registers the document photograph data at steps S221 and S223, and the O2O client 100 may transfer a document registration completion message to the user at step S225.

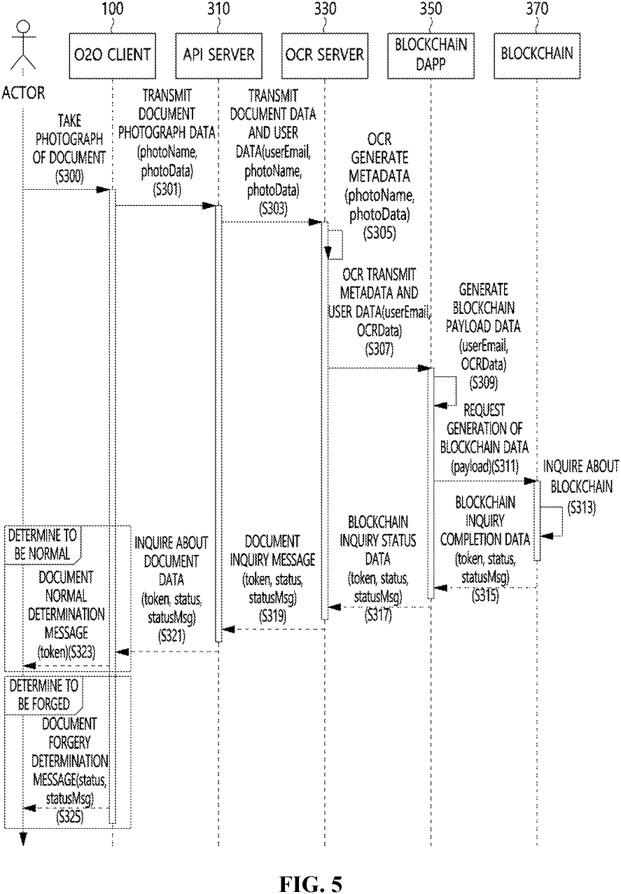

FIG. 5 is a flow diagram illustrating a certificate verification method according to an embodiment of the present disclosure.

Referring to FIG. 5, when a photograph of a document (i.e., a paper certificate) requested to be verified by a user is taken on the screen of the O2O client 100 at step S300, document photograph data (e.g., a certificate image) may be transferred to the API server 310 at step S301. The API server 310 may transfer the received document data, together with user data (e.g., a user ID), to the OCR server 330 at step S303.

The OCR server 330 may generate OCR data based on the received data, and may generate metadata from the OCR data in conformity with the format of metadata at step S305.

The DAPP 350 may transfers a token ID found in the database through the user ID to the blockchain 370, and may then search the blockchain 370 for the corresponding token at steps S309, S311, and S313. When the token is found in the blockchain 370, comparison target metadata may be fetched from the IPFS, and may be compared with the metadata of the certificate requested to be verified at steps S315, S317, S319, and S321.

When the comparison target metadata matches the metadata of the certificate requested to be verified, a document normal determination message may be transferred to the user at step S323, whereas when the comparison target metadata does not match the metadata of the certificate requested to be verified, a document forgery determination message and a message indicating the reason for forgery determination may be transferred at step S325.

Here, the process for verifying the certificate may be performed by a certificate verification apparatus or a certificate verification system, and the certificate verification system may include the API server, the OCR server, the blockchain DAPP, the blockchain, and a control unit, but the configuration thereof is not limited thereto.

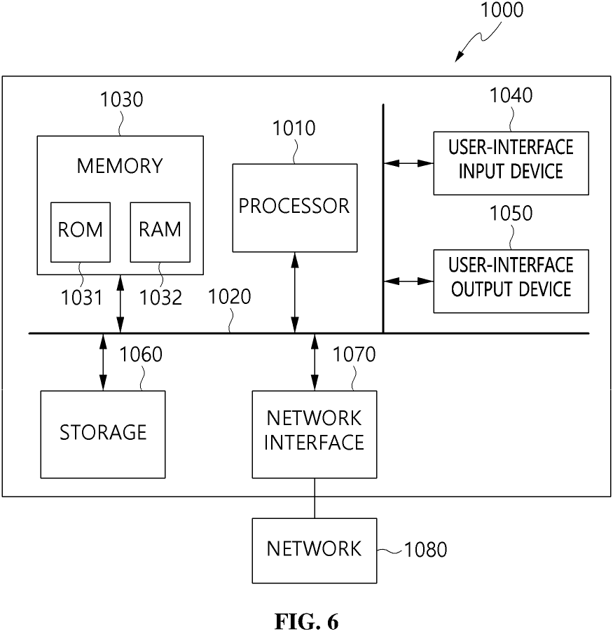

FIG. 6 is a block diagram illustrating the configuration of a computer system according to an embodiment.

Referring to FIG. 6, a computer system 1000 according to the embodiment may include one or more processors 1010, memory 1030, a user interface input device 1040, a user interface output device 1050, and storage 1060, which communicate with each other through a bus 1020. The computer system 1000 may further include a network interface 1070 connected to a network 1080.

Each processor 1010 may be a Central Processing Unit (CPU) or a semiconductor device for executing programs or processing instructions stored in the memory 1030 or the storage 1060. The processor 1010 may be a kind of CPU, and may control the overall operation of the certificate verification apparatus 200.

The processor 1010 may include all types of devices capable of processing data. The term processor as herein used may refer to a data-processing device embedded in hardware having circuits physically constructed to perform a function represented in, for example, code or instructions included in the program. The data-processing device embedded in hardware may include, for example, a microprocessor, a CPU, a processor core, a multiprocessor, an application-specific integrated circuit (ASIC), a field-programmable gate array (FPGA), etc., without being limited thereto.

The processor 1010 may receive a user ID and a certificate image, extract Optical Character Reader (OCR) data from the certificate image, generating metadata based on the OCR data, and verify a certificate by comparing content of a token registered in a blockchain as the blockchain with the generated metadata.

The memory 1030 may store various types of data for the overall operation such as a control program for performing a certificate verification method according to an embodiment. In detail, the memory 1030 may store multiple applications executed by the certificate verification apparatus, and data and instructions for the operation of the certificate verification apparatus.

Each of the memory 1030 and the storage 1060 may be a storage medium including at least one of a volatile medium, a nonvolatile medium, a removable medium, a non-removable medium, a communication medium, an information delivery medium or a combination thereof. For example, the memory 1030 may include Read-Only Memory (ROM) 1031 or Random Access Memory (RAM) 1032.

The particular implementations shown and described herein are illustrative examples of the present disclosure and are not intended to limit the scope of the present disclosure in any way. For the sake of brevity, conventional electronics, control systems, software development, and other functional aspects of the systems may not be described in detail. Furthermore, the connecting lines or connectors shown in the various presented figures are intended to represent exemplary functional relationships and/or physical or logical couplings between the various elements. It should be noted that many alternative or additional functional relationships, physical connections, or logical connections may be present in an actual device. Moreover, no item or component may be essential to the practice of the present disclosure unless the element is specifically described as “essential” or “critical”.

In accordance with the present disclosure, verification errors may be reduced by automatically performing the verification of forgery/counterfeit of certificates.

Further, the present disclosure may accurately determine the originality and integrity of certificates.

Furthermore, the present disclosure may prevent the occurrence of damage to documents that may occur due to an increase in the capacity of a server and improvement of server functionality.

Therefore, the spirit of the present disclosure should not be limitedly defined by the above-described embodiments, and it is appreciated that all ranges of the accompanying claims and equivalents thereof belong to the scope of the spirit of the present disclosure.

What is claimed is:

1. A certificate verification method using a Non-Fungible Token (NFT), comprising:
receiving a user Identification(ID) and a certificate image;
extracting Optical Character Reader (OCR) data from the certificate image;
generating metadata based on the OCR data; and
verifying a certificate by comparing content of a token registered in a blockchain based on the user ID with the generated metadata.

2. The certificate verification method of claim 1, wherein the certificate image is generated by scanning a paper certificate on a user terminal.

3. The certificate verification method of claim 2, wherein the paper certificate includes at least one of a test report, a test certificate, a certificate of qualifications, a certificate of a degree, a transcript or a vaccination passport, or a combination thereof.

4. The certificate verification method of claim 1, wherein the metadata includes a least one of a document number, an issuance date, an item or an expiration date, or a combination thereof.

5. The certificate verification method of claim 1, wherein the blockchain is configured such that the user ID, a token, and a Uniform Resource Identifier (URI) enabling corresponding information to access an InterPlanetary File System (IPFS) are registered in a form of [User ID, Token ID, URI].

6. The certificate verification method of claim 5, wherein the content of the token registered in advance in the blockchain includes comparison target metadata stored in the IPFS.

7. The certificate verification method of claim 6, further comprising:
when the generated metadata matches the comparison target metadata, providing a normal determination message to a user.

8. The certificate verification method of claim 6, further comprising:
when the generated metadata does not match the comparison target metadata, providing a forgery determination message and a message for explaining a reason for forgery determination to a user.

9. A certificate verification apparatus using a Non-Fungible Token (NFT), comprising:
a memory configured to store a control program for verifying a certificate; and
a processor configured to execute the control program stored in the memory,
wherein the processor is configured to receive a user Identification(ID) and a certificate image, extract Optical Character Reader (OCR) data from the certificate image, generate metadata based on the OCR data, and verify a certificate by comparing content of a token registered in a blockchain based on the user ID with the generated metadata.

10. The certificate verification apparatus of claim 9, wherein the certificate image is generated by scanning a paper certificate on a user terminal.

11. The certificate verification apparatus of claim 10, wherein the paper certificate includes at least one of a test report, a test certificate, a certificate of qualifications, a certificate of a degree, a transcript or a vaccination passport, or a combination thereof.

12. The certificate verification apparatus of claim 9, wherein the metadata includes a least one of a document number, an issuance date, an item or an expiration date, or a combination thereof.

13. The certificate verification apparatus of claim 9, wherein the blockchain is configured such that the user ID, a token, and a Uniform Resource Identifier (URI) enabling corresponding information to access an InterPlanetary File System (IPFS) are registered in a form of [User ID, Token ID, URI].

14. The certificate verification apparatus of claim 13, wherein the content of the token registered in advance in the blockchain includes comparison target metadata stored in the IPFS.

15. The certificate verification apparatus of claim 14, wherein the processor is configured to, when the generated metadata matches the comparison target metadata, provide a normal determination message to a user.

16. The certificate verification apparatus of claim 14, wherein the processor is configured to, when the generated metadata does not match the comparison target metadata, provide a forgery determination message and a message for explaining a reason for forgery determination to a user.
